(19) United States
(12) Patent Application Publication
(10) Pub. No.: US 2008/0268548 A1
(43) Pub. Date: Oct. 30, 2008

(54) Enhancing Raman spectrographic sensitivity by using solvent extraction of vapor or particulate trace materials, improved surface scatter from nano-structures on nano-particles, and volumetric integration of the Raman scatter from the nano-particles' surfaces

(75) Inventor: Matthew Mark Zuckerman, Woody Creek, CO (US)

Correspondence Address: GEORGE S. COLE, ESQ., 495 SEAPORT COURT, SUITE 101, REDWOOD CITY, CA, 94063, US

(73) Assignee: Nano Chocolate Lab, Inc.

(21) Appl. No.: 11/397,074

(22) Filed: Apr. 3, 2006

(51) Int. Cl. G01N 21/76

(52) U.S. Cl. 436/172

(57) ABSTRACT

This invention is a method to enhance by orders of magnitude accurate, real-time, stand-off detection by a sensor using Raman spectra of one or more trace compounds of interest (particularly explosives, bioterror organisms, or Volatile Organic Compounds). A colloid, whose medium of suspension is a liquid solvent with a weak Raman spectrum and in which are suspended particles of a noble metal that are preferentially nano-sized to maximize the surface-to-mass ratio for each particle, forms an impingement base. A sample of this colloid is air-pumped through a sampling module, exposed to air potentially carrying trace molecules from the compound of interest, then sent to a detection module that subjects the sample to Raman spectroscopy. The result is first corrected to obtain a unique Raman spectra from the trace molecules, then matched against Raman spectra in a database. Extensions include modifying, flushing, further processing, or recirculating the colloid sample.

### CROSS-REFERENCES

None

### GOVERNMENT RIGHTS

None

### OTHER PUBLICATIONS

1. Analytical Applications of Raman Spectroscopy; Pelletier, M. J., Ed.; Blackwell:Oxford, 1999.
2. Handbook of Raman Spectroscopy. From the Research Labortory to the Process Line; Lewis, I. R., Edwards, H. G. M., Eds.; Marcel Dekker: New York, 2001.
3. Low Resolution Raman Spectroscopy, J. Raman Spectrose., Clark, R. H., et. al., 30, 827-832 (1999).

### BACKGROUND OF THE INVENTION

Accurate detection and identification of particular chemical compounds or specific biological compounds—detection and identification sensitive enough to pick out, from a proportionately large volume of other molecules, a small number of trace molecules, or even a single trace molecule—is precisely what the sense of smell can do, reaching a parts per trillion sensitivity. Detecting and identifying particular compounds from trace exudates they give off that can be captured by a manufactured sensor has widespread potential uses in medical diagnostics, pathology, toxicology, environmental sampling, chemical analysis, forensics and numerous other fields. However, creating manufactured sensors that can match the performance of trained, domesticated animals has proven to be an elusive goal.

The sensitivity of living detectors has been known for centuries, whether such were truffle-sniffing hogs, physicians analyzing diseases through ‘whiffing’ serum samples, or the present-day drug-, explosive- and even cancer-sniffing canines. In the post-911 era there is an urgent need to develop sensors sufficiently sensitive to detect explosive, biological, and chemical materials at a stand-off distance and in real-time. Such sensors would meet society's needs and replace current sensors that either are simply not available, too intrusive, too remote, too expensive or difficult to provide in sufficient quantities, or sensors that produce information only with post-facto and often reduced importance—acting like newspaper headlines that report yesterday's news, or resembling a diagnosis arriving only after systemic deterioration, or providing a forensic reconstruction after a terrorist's explosion has wreaked havoc.

Explosives are still, a century after the Nihilists, the principal tool of terrorists. Five of seven recent, major, terrorist attacks on U.S. facilities used high explosives: the 1983 truck-bomb attack on a U.S. Marine barracks in Beirut (63 killed, 120 injured); the 1995 truck-bomb attack on the Alfred P. Murrah Federal Building in Oklahoma City (168 killed, 500 injured); the 1998 bombings of U.S. embassies in Tanzania and Kenya (81 killed, 1,700 injured); the 2001 boat-bomb attack on the U.S.S. Cole (17 killed, 37 wounded); and the 2003 car-bomb attack on the United Nations Headquarters in Baghdad (22 killed/100 injured. There now are almost daily occurrences of “curb side”, “improvised explosive devices” in Iraq, a spreading use of car and truck bombing of civilian areas or governmental facilities from Bali to Spain, and even human suicide bombers attacking transport-related human collectors such as the London Tube.

There are also biological hazards, both artificial (such as the mail-carried anthrax ‘bombing’ of Government personnel in Washington, D.C.) and natural (such as cancer or infectious disease), where the chief obstacle to cost-effective prophylaxis that can identify, limit, and treat any outbreak, is the delay in detection. It is not a lack of causal knowledge on the part of physicians and pathologists; it is the societal inability to replicate and distribute dependable, sensitive, and accurate real-time sensors. The same is true for detecting drugs or contraband while in transport. It takes years, or at least months, to train each single canine (and its handler); and they cannot be either warehoused against future need or simply ‘put back on the shelf’ after a particular crisis.

Smell is the sense with sufficient sensitivity and specificity, as might be expected after millions of years of evolutionary development of this sense. Consider this: it only takes a second for a passenger in one car to smell the exhaust of an older car. Sensitivity measures the ability to find the explosives' vapor in a sea of air. Specificity measures the ability to identify exactly which explosive is present, from the tell-tale vaporization of trace compounds. These two interact to determine a sensor's effectiveness and reliability. Nowadays, physics can replace chemistry and be used to detect the presence of explosives. Technology now has the capability of accurately operating in the nano-scale in the lab; and the prior art has taught means to improve the sensitivity and specificity of one or more chemical sensors.

Sensitivity: Sensitivity is measured in parts of the explosive's exudate vapor in the atmosphere. It is analogous to looking for a black ball in a flow of white balls. The ultimate detection is to find one part of a particular chemical compound (black ball) in a sea of mostly homogenous gases (white balls). The good news is that is even at a concentration of one part per trillion, each cubic inch of TNT continually emits about 8 billion molecules (black balls) of exudate vapor. The bad news is that these 8 billion molecules (more than one for every person living on the planet) rapidly dissipate into a far, far vaster and generally amorphic atmosphere. At a sensitivity of a part per billion, explosives can be detected at 50-100 feet by a stand-off sniffer. At a sensitivity of a part per trillion, explosives can be detected by air samples taken from a vehicle traveling at 60 mph (88 feet per second)—time enough to give warning of an Improvised Explosive Device ahead that has been emplaced some time beforehand.

Specificity: Specificity is the measurement of the accuracy of identification. It is not enough to detect “a” smell; specificity is the ability to define what the presence of a particular, specific smell means—to recognize that the presence of one or more trace molecules signals the presence of one or more particular compounds of concern. Specificity is what allows a sensor to put meaning into the detection, or in other words, what allows a sensor to link the presence of a particular trace compound with the presence of an explosive, or even a determination whether that explosive is C-4, Semtex, gun powder, dynamite or other. For an explosive detector such as the preferred embodiment of the present invention, specificity would compare the spectrum of the explosive's vapor found in air to the spectrums of the following dozen compounds for which acetylnitrile is the “Solvent of Choice”: TNT, PETN, RDX, HMX, TATP, HMTD, Tetryl, EGDN, TATB, NTO, NC, and TNAZ.

People have long wondered if it might be possible to emulate biological sensitivity and specificity, if working means could be found to concentrate the trace compounds given off by explosives into the atmosphere. The present invention teaches how this can be done by using solvent extraction, surface impingement, incident laser light and analysis of the resulting emitted Raman spectrum of the sample in a nano-based sensor, to identify the presence of the chemical compounds of concern.

It may help, in order to put the sensitivity and specificity of a ‘nano-based’ sensor into perspective, to recognize that the Gross National product is measured in the trillions, or that if every person of the U.S. were only one nanometer tall, and if each person was stacked one on top of the other, the resulting figure would only be less than 12 inches in height. The sensor described herein is operating at or even below the biological level of compactness of capability.

Raman spectroscopy focuses a beam from a light source (generally a laser) upon a sample to generate inelastically-scattered radiation, which is optically collected and directed into a wavelength-dispersive spectrometer, in which a detector converts the energy of impinging photons to electrical signal intensity. When the beam of light is focused on the sample, some photons are absorbed by the material comprising the sample and other photons are scattered. The vast majority of the scattered photons have the same wavelength of the incident photons. This identical wavelength photon scattering is known as Rayleigh scatter, where the electron decays back to the same level from which it started. But a minute portion of the scattered photons are shifted to different wavelengths. This wavelength-shifted photon scattering is called Raman scatter, and arises from inelastic scattering of incident photons due to electronic transitions with the sample's molecules. Only some one ten-millionth (1 to the 10⁻⁷) of the total scattered photons are subject to Raman scatter.

Most Raman scattered photons are shifted to longer wavelengths (this is the ‘Stokes shift’), but a small portion are shifted to shorter wavelengths (this is the ‘anti-Stokes shift’). For each Stokes and anti-Stokes shift, an incident photon excites the electron into a higher virtual energy level (“virtual state”) and then the electron decays back into a lower level. During this process a scattered photon is emitted. In a Stokes shift, the final energy level is higher than the starting level; in an anti-Stokes shift, the final energy level is lower than the starting level. The dominance of Stokes shift Raman scattering stems from the fact that at normally encountered temperatures, the electrons that receive the incident photons are most likely to be in their lowest energy state (in accordance with the Boltzmann distribution). Most Raman spectroscopy in the prior art uses the Stokes shift alone in order to compensate for the absolute paucity of any Raman scatter, because the Stokes region has significantly more energy than the anti-Stokes region and the probability of Raman interaction occurring between an excitatory light beam and an individual molecule in a sample is very low, which contributes in a low sensitivity and limited applicability of Raman analysis.

The resulting emission scatter is called a Raman emission spectrum and is characteristic of the specific molecular compound in the sample. Every compound exhibits a unique Raman spectrum arising from that compound's molecular vibrations. The wavelengths of a Raman emission spectrum are characteristic of the chemical composition and structure of the molecules in a sample, while the intensity of Raman scattered light is dependent on the concentration of molecules in the sample. The Raman spectrum of a compound is a plot of these energies and identifies that compound.

The Raman spectrum of a sample will incorporate two parts: that which is due to the pre-exposure composition of the sample (the base), and that which is due to the post-exposure inclusion of one or more trace molecules (the detection target). The base will include both the known and intended composition (the background), and some pre-existing but unknown contamination or impurities (the ‘noise’). The target will include, proportionately, the contacted molecules from the sampling volume (the signal). Computers now allow us to remove from a given Raman spectrum the part that arose from the base (the background). There still remain problems in isolating the signal from the noise.

Despite the fact a Raman sensor's sensitivity theoretically could allow detection of a single trace molecule of a particular compound out of all the molecules in a particular sample, due to several technical difficulties existing Raman sensors still have very limited applications. Specifically, a first, and major, limitation of Raman spectroscopy application is the weakness of any Raman scattering signal for trace molecule detection. There are many efforts in attempt to resolve this problem of a weak scattering signal. However, such efforts still have very limited success and have not been able to make Raman detectors available for practical and economical applications that urgently require ultra-sensitive chemical trace detections. What has been sought are better ways to enhance the signal and correct for the noise—and the background, too.

It is well known in the art that one potential solution is employing a roughened or nano-structured sensing surface (usually of a ‘noble’ metal, that is gold, silver, or copper) as an impingement surface, in order to generate scattering signals of higher intensity. One application of sensing technologies with nano-structured materials is Surface Enhanced Raman Spectroscopy (SERS). SERS is usually accomplished by using either rough metal films which are attached to a substrate as part of the sample cell of the spectroscopic measuring device, or by introducing metallic particles as part of a suspension in a liquid to form a colloid, into the sample cell. Current state of the art uses what are sometimes referred to as “colloid-sized” particles (5 to 5,000 angstroms), that do not settle out rapidly and which are not readily filtered.

It is known that a Raman scattering signal can be enhanced by 10⁴ to 10¹⁴ times when trace molecules are adsorbed on a nano-structured noble metal surface. It is also known that a Raman scattering signal gets enhanced if the size of the impingement material is reduced from colloid-sized to nano-sized to drastically increase the surface-to-mass ratio average for such particles. This enhancement is determined by several factors (among them, the dimensions of the nano-particles and the distance between these nanoparticles). As the scale of these nanoparticles decreases, the signal enhancement of Raman scattering increases. Further, there is a correlation between the distance between neighboring nanoparticle islands and the enhancement effect of Raman scattering. But technical difficulties constrain fabrication of nano-structure surfaces with reduced dimensions and reduced distance between such nano-particles.

A second major problem has been technical difficulties in fabricating a non-contaminated, nano-structured, noble metal impingement surface. A non-contaminated, nano-structured, noble-metal impingement surface was presumed to be a requirement for for molecular adsorption and subsequent measurement in field-deployable sensors. Due to this problem, even though controlled-environment, laboratory detection of trace chemicals can be achieved at a part-per-billion (ppb) level, the techniques of applying SERS for real-time, real-world detection of trace of explosives and/or other chemical materials remains a challenge. When the impingement surface is continually exposed to the outside environment without cleansing, the risk of disqualifying contamination rises at least linerally with time.

An alternative solution employs nano-sized noble metal particles in a colloid where the particles form the impingement surface. This has the obvious problem of lining the impingement surface up with the laser emission; if the colloid is not in the beam, the contained particles emit no Raman spectrum. Successful detection of a trace molecule(s) requires both that the trace molecule(s) be present in the sample and then having the spectroscopy beam impinge that sample where the trace molecules are present. Again, the problem of continual exposure without cleansing creates the risk of disqualifying contamination over time.

A third problem particular to this alternative solution is that reliable methods for producing metallic colloids with consistent SERS performance have not yet been developed. In addition, there are only a limited number of biomolecules (such as, for example, proteins) that adsorb to metallic surfaces to generate a SERS signal, and even for proteins that do adsorb, the signal intensity is low.

A fourth problem, previously mentioned, is the need to cleanse or otherwise return the impingement surface that is used by a Raman detector to its pre-contact state. Because if this is not done, the detector is only good for a ‘one-time’ use; once the impingement surface has been ‘switched on’, it will continue to report the presence of the trace material until that trace material is removed. This is true whether the impingement surface is fixed or a floating colloid. But each change risks introduction of contamination (more noise) and thus degrading the sensor.

Finally, a fifth, orthoganol, problem in realizing any enhancement in detecting a trace molecule(s), is that of balancing increased sensitivity against the ability to disregard both the background and any noise. For a particular trace molecule to be detected, it must be distinguished from a background of other molecules present in the sample. The prior approaches focused on minimizing the background contribution, using the smallest possible sample volumes. This is because background noise is proportional to the sample volume, while the signal from a trace molecule is both independent of the sample volume and directly correlated to the concentration in the sample volume of the molecule(s) to be detected. Raman detection of small numbers of molecules considered using sample volumes of 10 pL or less, to reduce the background noise. What was not realized was the distinction between surface and volume greatly affects both the adsorption of the trace molecule onto the impingement base, and the subsequent detection by Raman spectroscopy.

Raman spectroscopy offers many of the ideal characteristics of a sensor to detect the presence of air-borne trace molecules of a compound of interest, whether such are particulates or vapors. A Raman spectrometer's benefits include having a signal output proportional to the amount of the target material present in air, a fast response time, a favorable “signal to noise ratio”, being compatible with a simple electrical circuit, experiencing minimal drift with time, being highly sensitive, offering selectivity, incorporating minimal or no hysteresis, and having a long service life, reasonable maintenance, low power consumption, and moderate cost of manufacture. All one has to do is solve the problems mentioned above!

A Raman spectrometer uses Raman spectroscopic analysis to identify the Raman spectrum of a target trace molecule(s) from the background and noise, where that spectrum forms a “fingerprint” that is specific to each unique trace molecule, preferably one that incorporates frequency peaks that are non-overlapping for the different molecules of the background, noise, and target, and thus has a favorable “signal to noise ratio”. Further, as Raman spectroscopic analysis requires only illumination of a sample, it is a non-destructive and non-contact protocol. Each target spectrum can be acquired in seconds or less, so a Raman spectrometer could support “real-time” sensor applications. And, if means were found to return the sensor to its base condition after detection, the sensor could also be used for monitoring as well as one-time uses.

A Raman spectrometer comprises Illumination, Collection, Isolation, and Spectrographic elements. A laser is chosen for the Illumination element, because a laser has good wavelength stability and low background emission. The laser's coherent beam of monochromatic light illuminates the sample with sufficient intensity to produce a meaningful quantity of Raman scatter and a spectrum free of extraneous bands. Technological advances in computers and lasers for use in the Raman spectrometer's elements of Illumination and Spectrograph have made possible reduced cost, improved performance, lowered power requirements, reduced size and portability.

The Collection element for any Raman spectrometer is significantly improved by using charged coupled devices (CCDs). CCDs are a class of array detector comprising a large number of identical individual detectors that simultaneously measure the intensities of light incident on the detector. CCDs operate by generating electron hole pairs in a photosensitive material above a pattern of electrodes positioned below the surface that attracts local photoelectrons. The photosensitive material and the electrode, when taken together, form an individual detector element in the larger array. Typical conditions are illumination at 785 nm and Raman scatter measured in the 250 to 1,800 nm range.

The Isolation element filters out the background signal(s) and Rayleigh scatter to send the Raman scatter to the Spectrograph element, both of which are known or testable before the sensor begins to operate, as the background (of impingement surface, and/or pre-exposure colloid, and laser's emission frequency) is both known and stable during the period of use.

The Spectrograph first separates the Raman scatter by wavelength by passing the photons through a transmission grating to an intensity detector, next records the intensity of the Raman scatter at each wavelength, and then plots the Raman spectrum as a function of a frequency difference from the incident radiation of the laser. This difference is called the Raman shift and is independent of the frequency of the incident light because it is a difference value.

Detecting a compound through a sensor requires that the sensor capture trace molecules of a compound being tested for in the sample that is tested. These trace molecules can be of the compound itself, or of a known vapor, if the compound incorporates any volatile substance. The sample may be gaseous, liquid, or solid—though in the preferred mode of the invention, the sample is liquid or a solution of the material of interest in one or more solvents.

Detection methods for the presence of high explosive agents have, for the most part, relied on finding particles (also called ‘residuals’) from the explosive material that form on the exterior of the containers that contain these explosive materials. The generally accepted procedure is to wipe such exterior surfaces with a Teflon® impregnated cloth and then test the cloth for the presence of the particles. This method does not allow a non-contact, stand-off detection, and the container(s) may incorporate vibration or contact triggers. (In which case the detection will be both explosively obvious arid too late to do much good.)

Explosives incorporate volatile substances (some consider explosives the epitome of what is meant by a ‘volatile’ substance). Explosive materials and other agents of interest thus produce particulate or vapor traces that can be used for stand-off detection. Plastic explosives (as their name implies) can be hand-shaped without chemical treatment, molds, or special tools, and when handled take on sticky rubber-like physical properties. There are some 20 formulations of plastic explosives. The most common of the formulations are: Compositions A, B and C, HBX, H-6, and Cyclotol. All six compositions contain RDX, and four of the six compositions contain TNT as well as RDX. However, RDX, which is present in all plastic explosives, has a vapor pressure of 1×10⁻⁹ millimeters of mercury (lower than TNT), which makes it fall below the detection limit for Raman spectroscopy as it exists today.

Volatile Organic Compounds (‘VOCs’) can be captured in aerosol or liquid samples. VOCs, principally alkanes, benzene derivatives and such ‘aromatic compounds’, have been identified in breath from patients with lung and breast cancers. Other VOCs such as formaldehyde, methylalkanes, pheomelanin, eumelanin and eumelanin precursor metabolites, can be detected in the headspace of urine samples for bladder, prostate, and melanoma cancer patients. It is theorized but not proven that such VOCs are what the cancer-sniffing canines are picking up on.

### SUMMARY OF THE INVENTION

The method to increase the Raman effect by multiple orders of magnitude by impingement and solvent-enhancement, thus enabling a real-time, stand-off sensor, comprising:
1) Selecting as an impingement base a colloid, said colloid comprising:
   (i) a liquid solvent serving as the medium of suspension, said liquid solvent preferentially both having a neutral or weak Raman spectra and being strongly attractive to the trace molecules of the compound of interest; and,
   (ii) particles of a material suspended in the liquid solvent, said particles of material preferentially being both strongly attractive to any trace molecules of the compound of interest and, to maximize their surface-to-mass ratio, being on average nano-sized; (e.g., for at least one explosive, an aqueous solution containing noble-metal nano-particles);
2) taking a sample of the outside environment by pumping the colloid through a sampling unit, thereby exposing the colloid to the external medium where any trace molecules of the compound of interest may be present;
3) maximizing, throughout the volume of the sample, the surface-to-surface interaction between the medium and the colloid, thereby maximizing the interaction between the surfaces of the suspended particles with any trace molecules;
4) binding one ore more of the particles within the colloid with the one or more trace molecules, as a result of such interaction;
5) optionally, further processing said sample and colloid so that the one or more trace molecule(s) of the compound of interest are concentrated in the colloid;
6) focusing a preferably monochromatic laser light on said colloid;
7) generating thereby Raman spectra from said colloid;
8) optionally, performing a volumetric integration of the Raman Scatter from the nano-particles' surfaces over the entire volume of the sample, to produce a generated Raman spectra;
9) eliminating from the generated Raman spectra both Rayleigh scatter and Raman scattering from the pre-contact colloid, thereby producing a reconstructed Raman spectra of any of the trace molecules of the compound of interest;
10) comparing said reconstructed Raman spectra to a database containing Raman spectra of known compounds to determine the presence and concentration of one or more of the trace molecules of the compound of interest; optionally,
11) repeating steps 1-9 for continued concentration of the trace molecules of the compound of interest until a positive result is obtained; and/or again optionally,
12) flushing the sensor of the now-contaminated colloid, and restarting the method at step 2 by pumping in new, uncontaminated colloid; and,
13) reporting the results of the above steps.

### DETAILED DESCRIPTION OF THE INVENTION

Most prior inventors have focused on one or more aspects of a Raman spectrographic sensor, not on the problems as a whole of using such. The present invention combines strengths from different aspects and differs—almost contradicts—assumptions and preferences in the prior art. Most prior art in this field focused solely on enhancing Raman spectroscopy. In Raman spectroscopy, energy transitions arise from molecular vibrations involving identifiable functional groups. The Raman spectrum of a compound is a plot of these energy transitions and identifies that compound. Most prior art considered a two-dimensional (planar) scanning analysis preferable, partly because Raman bands arise from a change in the polarizability of the molecule.

To detect one or more trace molecules of a compound of interest requires sampling the environment in which they may exist, then bringing any such molecules present to the detection means. Moving, concentrating, and positioning these trace molecules easily, swiftly, and accurately to the focusing point or plane of a detector has been one of the problems in the field; concentrating the trace molecules in order to enhance detection, another. Cleansing and resetting a sensor after a positive test has also not been adequately addressed for short-cycle-time or re-usable embodiments.

The present invention recognized that perceived drawbacks—one from another form of vibration spectroscopy, Infrared (IR), and one from the above-mentioned polarization geometry—provided insight leading to an improved solution. The focus of the present invention is on maximizing the surface-to-surface impingement between the trace molecules contained in the air sample and the particles of the noble metal, which meant maximizing the surface-to-volume factors of the liquid solvent and the noble metal particles themselves, as well as all surface-to-surface interactions; then maximizing the chance of detecting the impingement for a given mass of air being sampled and then scanned at the Raman spectroscope. All of the above are served by using an air pump and mixing coil to maximize the air-liquid and molecular surface-to-surface interface interactions, and then three-dimensional (volumetric) scanning of the colloid and integration of the resulting spectra, which allows rapid concentration of the trace molecules present as well as effective motion and positioning of the sample through the sensor.

In IR spectroscopy, detection of a compound arises from a change in the dipole moment of the molecule. The IR spectrum of water and other selective solvents is generally considered to be strong and complex, making IR inadequate for measuring solutes in aqueous solutions. However, the Raman spectrum of water (and some other selective solvents) is weak and unobtrusive, allowing readier acquisition of Raman spectra for any trace molecule solutes in aqueous and other solvents, by correcting the detected emissions for those parts of the combined wavelengths known to be present in the pre-exposure solvent. Instead of masking the trace compound's spectra, the spectra from the mask, that is, the solvent, can be removed and a corrected Emitted Light Spectra unique to the trace molecules uncovered with Raman spectroscopy.

Using three-dimensional, biplanar plotting and comparison of Raman spectrographic results from using a liquid solvent strongly attractive to the trace molecules of the compound of interest, preferably an aqueous or similar chemical composition to interact with the medium (preferentially, and hereafter, presumed to be air, but potentially liquid) being sampled whose volume contains such trace molecules. This means that detection enhancement can be obtained even while ready cycling, concentrating, and post-detection flushing and clearing can be done.

Several additional extensions use dual, or multiple, solvent combinations, laser illuminations, planar comparisons, or additional steps to further enhance the sensitivity of the above method. More specifically, different wavelengths of laser illumination (preferentially using the red spectrum, the green spectrum, or both together) are disclosed herein.

This capability is enhanced when the air sample containing the trace molecules is cycled through the sensor using an air pump, a technique that is well-known in the prior art. The liquid solvent strongly attractive to the trace molecules of the compound of interest forms the medium of suspension of a colloid in which are suspended particles of a noble metal (preferentially nano-sized to maximize the surface-to-volume ratio for each particle), that mixes with the air being sampled. Ensuring a thorough air-liquid mixing through induced turbulence by moving the air sample and liquid colloid through multiple twists and turns further improves interaction between the air sampled and the solvent in an atmospheric-based detector as external air is sucked in and swirled while passing between the sampling and detecting units; this greatly increases surface impingements between the trace molecules of interest and the surfaces of the noble metal particles and increases the concentration and thus resultant sensitivity. By using the method and apparatus described herein, even traces from compounds such as Royal Demolition Explosive (RDX; the material present in plastic explosives), which expresses a low vapor pressure of only 1×10⁻⁹ millimeters of mercury, can be detectable in real-time, stand-off uses.

An additional extension to the method and apparatus increases the sensor's flexibility and usability through programming the sensor to detect one or more trace molecule(s), by a) introducing a sample containing desired trace molecules, engaging in the above selection, etc. to produce a resulting Raman spectra; b) adding that resulting Raman spectra to the database; and c) subsequently testing samples against the now-expanded database.

An additional extension to the method and apparatus increases the Raman effect by multiple orders of magnitude as above, but focuses on one or more trace molecule(s) from any of a) an active biological agent (including smallpox, Ebola, or Anthrax); b) a biological toxin (including Botulinum or plutonium); c) a dissolvable aerosol-distributable toxin (including Sarin gas or Dioxin); or d) any representative of explosive chemical agents (including both TNT and RDX).

An additional extension to the method and apparatus increases the Raman effect by multiple orders of magnitude as above by using an impingement base made from porous silicon of nano-size structure; and a second additional extension uses an impingement base made from materials used in Affinity type High Performance Liquid Chromatography (HPLC).

An additional method and apparatus increases the Raman effect by multiple orders of magnitude by using a second solvent to extract the trace molecule(s) from the colloid, selecting this second solvent from a group of solvents, each of which are both capable of solvent-to-solvent extraction and concentration of the trace molecule(s) and have a Raman spectrum that is weak and unobtrusive compared to the trace molecule(s).

An additional method and apparatus increases the Raman effect by multiple orders of magnitude by using a solvent that extracts the trace molecule(s) of one or more Volatile Organic Compounds particular to the target of interest from the sample, thus forming one or more solutes, and the Raman spectrum of the selective solvent is weak and unobtrusive allowing the acquisition of the solutes Raman spectrum in aqueous and other solutions.

An additional method and apparatus increases the overall efficiency of the detector by flushing the impingement base, returning it to a pre-detection neutral state and allowing re-use.

The present invention is a method to increase the magnitude of the Raman scattered light to recover some or all of the seven orders of magnitude less Raman scatter as compare to Rayleigh scatter. The method concentrates the trace molecules of a compound of interest by maximizing the impingement and consequent adsorption between any trace molecule and the surface of one or more particles of a noble metal in a colloid, by maximizing the air-to-liquid interface surface between the air being sampled and the colloid as well as maximizing the surface-to-volume ratio of each particle of a noble metal, and then delivering the newly formed solute to a Raman spectroscope and taking a reading of the now-contaminated sample. The present invention utilizes chemical separation methods and materials which, when combined with Raman spectroscopy, form an unexpected result of lowering the detection level for trace molecules of the compound material of interest. This method can also be used with a mixture of solvents, means for further concentrating the trace molecules within the colloid, or for a mixture of compounds of interest, and can be re-set and re-used by flushing provably contaminated samples; or can be used to program the sensor to test for a previously unknown compound of interest through introduction of a sample containing trace molecules of the new compound and entering the resulting Raman spectra into the database.

In further extensions of the invention, the sampling unit uses a mixing unit for each different solvent comprising the liquid in the colloid (e.g. one for acetonitrile, one for methanol, and one for water), with these mixing units being either serial or parallel with each other.

Surface-enhanced Raman spectra (SERS) has used colloidal-sized gold for red light excitation and colloidal-sized silver for green light excitation. In the present invention nano-sized materials are used to increase the surface area per unit of mass so that small quantities of precious metal are required and a large increase in the sensitivity can be obtained. The nano-sized gold can be produced from a solution of gold chloride in water reduced with borohydride. The theoretical explanation that the present invention has adopted for the increase in sensitivity associated with impingement, uses electromagnetic rather than chemical theory. Under the electromagnetic theory a local electromagnetic field is created at the metal substrate as an enhancement of the field associated with the incident light owing to believed to be correct theoretical mechanism of generation of surface plasmons.

Colloidal-size particles of 1,000 nm (1 micron) in diameter have approximately 1 square meter of surface area per gram of mass. Nano-size particles of gold and silver of 10 nm in diameter, the particles used in the present invention have, 1,000 times or three orders of magnitude greater surface area than colloidal-sized materials and approximately 15% of their molecules on the surface. This increased in surface area available for the plasmoid effect associated with the use of nano-sized particles of precious metals is an element of the present invention.

The choice of solvent is matched to the choice of red or green excitation light, and is based on the segregation of the compounds of interest based on each compound's inherent florescence and solubility in the solvents. The solvents of choice (A, B, or C) for specific explosive compounds are shown below. Acetonitrile (A) is the solvent of choice to strip a dozen explosive compounds from air. Methanol (B) is the solvent of choice for two additional explosive compounds; and water (C) is the solvent of choice for five additional explosive compounds. In the present invention Acetonitrile is the preferred solvent. In another embodiment of the present invention methanol and/or methanol and water are used in a second and even third channel (or sets of channels) in order to cover the entire range of twenty explosive compounds.

A. Acetonitrile: Solvent of Choice for Extraction for explosive compounds:
2,4,6-trinitrotoluene (TNT)
Pentaerythritoltetranitrate (PETN)
Hexahydro-1,3,5-trinitro-1,3,5-triazine (RDX)
Octahydro-1,3,5,7-tetranitro-1,3,5,7-tetrazine (HMX)
Triacetone triperoxide (TATP)
Hexamethylenetriperoxidediamine (HMTD)
Methyl-2,4,6-trinitrophenylnitramine (Tetryl)
Ethylene glycol dinitrate (EGDN)
Triaminetrinitrobenzene (TATB)
3-nitro-1,2,4-triazol-5-one (NTO)
CI-20
Nitrocellulose (NC)
1,3,3-trinitroazetidine (TNAZ)

B. Methanol: Solvent of Choice for Extraction for explosive compounds:
Nitroglycerin (NG)
Picric acid (PA)

C. Water: Solvent of Choice for Extraction for explosive compounds:
Ammonium nitrate (AN)
Ammonium perchlorate (AP)
Ammonium dinitramide (AND)
Potassium nitrate (PN)
Potassium perchlorate (PP)

An additional extension of the present invention uses an unexpected result. Defocusing the incident laser illumination at the detection point excites the volume of the colloid, and collecting the results and performing a volumetric integration of the Raman scatter from the nano-particles' surfaces, allows for an enhanced (not diffused) signal.

Another extention also reflects an unexpected result; by changing the plane of the circulation of the colloid through the Detection unit, the retention time of a particular unit being sampled can be adjusted. Moving the flow plane for the colloid between a vertical and 45-degree angle can increase or decrease the travel time and either increase the detection or decrease the latent time between any trace molecules entering the sensor and being detected.

The following figures illustrate, but do not limit, the present invention.

### BRIEF DESCRIPTION OF THE DRAWINGS

FIG. 1 shows a typical Raman Spectrum unique to a particular compound.

FIG. 2 shows a block diagram for scrubbing explosive vapors from air to detect and identifying a variety of explosives.

FIG. 3 shows a block diagram of a preferred embodiment of the invention.

FIG. 4 shows a block diagram for the preferred embodiments of surface impingement.

FIG. 5 shows a block diagram of the extraction module.

### DETAILED DESCRIPTION OF THE DRAWINGS

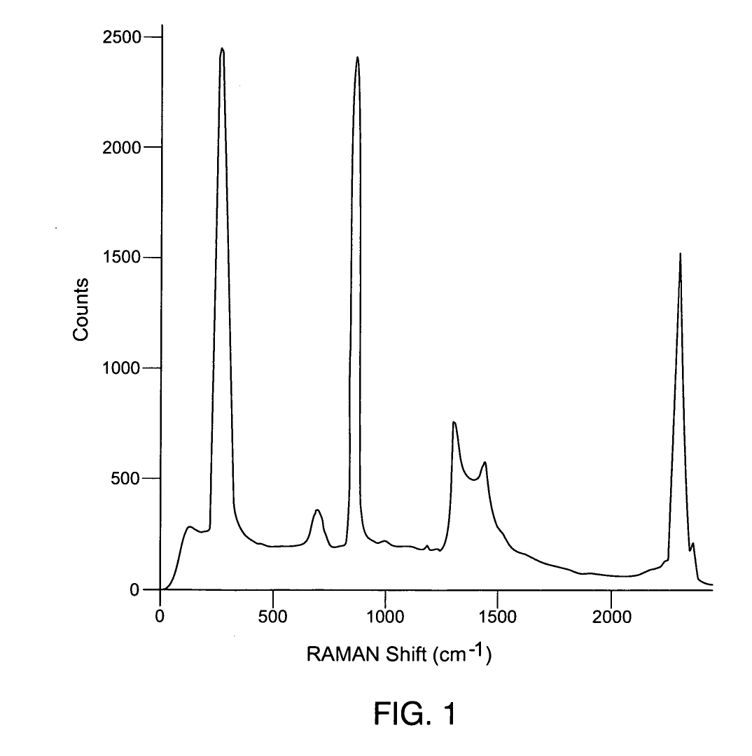

FIG. 1 shows a typical Raman Spectrum that is used to identify a material with each peak indicating the presence of significant illumination (the height showing the number of positive counts of a particular wavelength of light being emitted from the compound, and the combination of specific wavelengths where the peaks occur indicating the presence of a particular compound. In the particular embodiment of the invention, the final spectrum is corrected by removing the known wavelengths for the background and frequency of the laser used. The X-axis is measured in Raman shift in cm⁻¹ and is measured relative to the excitation wavelength and the Stokes' lines, which are lower energy lines than the excitation wavelength form the spectrum of interest which in a fingerprint that uniquely identifies the material. Excitation in the preferred embodiments of the present invention is by a laser at either 785 nm or 532 nm. The Y-axis is measured in counts incident on the CCD detector at or around the wave number.

For excitation wavelength 785 nm (the preferred range is 785 nm to 996 nm), which is 12738.85 cm⁻¹ and produces about 2700 cm −1 on the lower energy side, from 12738 cm −1 to about 10038 cm −1, which corresponds to a range of about 996 nm. For excitation wavelength 532 nm (532 nm to 676 nm), which is 18797 cm⁻¹ and produces about 4, 027 cm⁻¹ from 18797 cm⁻¹ to 14769 cm⁻¹, which corresponds to a range of about 1,486 nm. The range is larger at an excitation wavelength of 532 nm than at 785 nm because the CCD detector has larger range at 532 nm.

Today's Explosive measurement used at airports, requires contact with particles of the explosive materials. The Company's product detect remotely, at a stand-off distance without need to have particulates present, the vapors of dozens of explosive chemicals that are used in TNT, plastic explosives and most other commonly encountered explosives. Raman spectroscopy can uniquely determine the identity of explosives. Recent advances in CCD cameras, computers, fiber optics and wireless technologies have made it possible to bring Raman out of the laboratory and into the field at lower cost and more rugged formats. Raman spectroscopy with its powerful specificity for identification has historically lacked sensitivity. The Company's products utilizes a proprietary technology to extract and concentrate the explosive materials vapors from air to be sufficiently sensitive to detect explosives remotely.

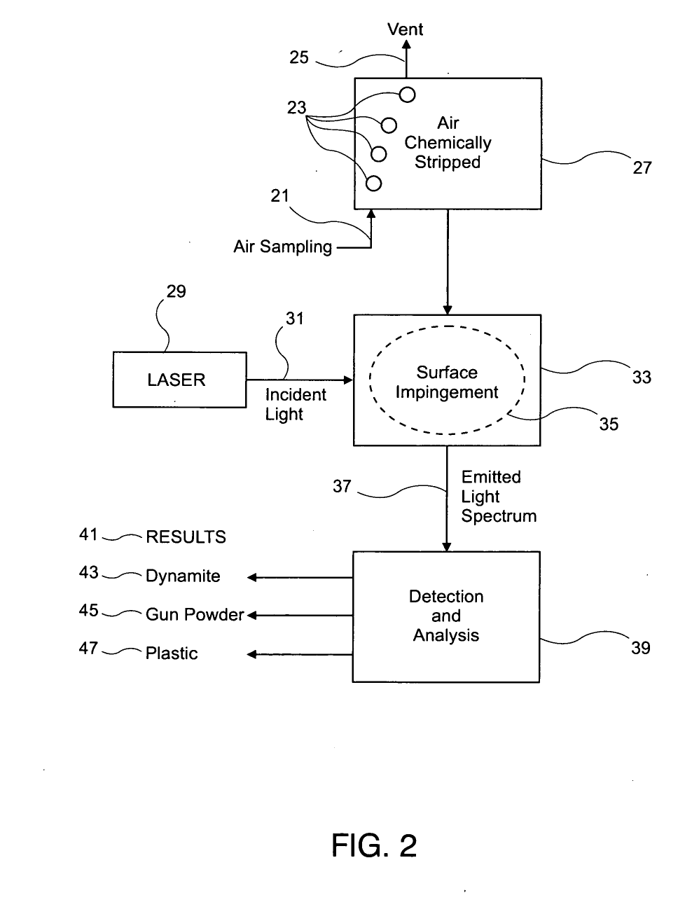

FIG. 2 shows a block diagram for scrubbing explosive vapors from air to detect and identifying a variety of explosives including, C-4, Semtex, gun powder, dynamite, and other explosives at standoff distances by identification of the fingerprint energy signature by coupling portable Raman spectroscopy, chemical extraction and surface impingement to achieve part per billion of better detection. This detector works from distances of 10-30 feet when testing with 1/10^{th} to 4 of a pound of explosives and 50-100 feet when testing with one pound of explosives or more. Detection and location of explosives will not be stopped by placing the explosives in double-steel-walled vessels or even metal safety box.

Air which may contain one or more trace molecules of a compound of interest (one that the sensor is set to sense), is drawn into a vent (1) through a sampling port (21) into a Preparation Unit. Here the air is mixed and the trace molecules interact with a colloid made from a liquid solvent as described above, containing nano-sized particles of a material, which in the preferred embodiment is a noble metal (23, not to scale). The majority of the air is then released to the outside through an exhaust vent (25), while the colloid is delivered by air pumping or other means to the Raman Spectrometer (33).

Once the colloid is in the Collection unit (35) and at the focal point of the Raman Spectrometer, the Illumination element, a laser (29) shines the incident light of a known, specific frequency (31) through the colloid. This produces a Raman-shifted, Emitted Light Spectra (37).

The Raman-shifted, Emitted Light Spectra (37) is then processed by the Detection and Analysis unit (39), which strips out the background wavelengths that arise from the original colloid (that is, the combination of the liquid solvent and the suspended nano-particles) used to maximize the surface impingement of the trace molecules (neither shown, but present). The Detection and Analysis unit then compares the resulting corrected Raman spectra against those contained in a database (neither comparison means nor database are shown, as these are well known in the art) and reports its results (41). When the Detection and Analysis unit finds a positive match between the processed Emitted Light Spectrum and that on record for one or more of the trace molecules of the compound of interest, whether this is Dynamite (43), Gunpowder (45), or Plastic Explosive (47), it records and signals that finding. If, for a particular run, no trace molecules have been found, the colloid may be recycled through the Preparation unit for further exposure and possible concentration of any trace.

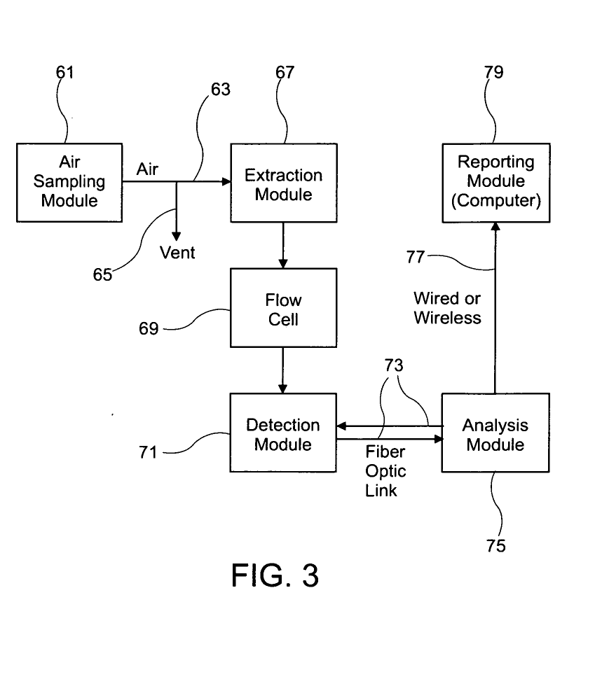

FIG. 3 discloses more detail of the Preparation Unit. The air to be tested, having been drawn in through the sampling port (21; not shown in this drawing), is passed over (63) to an Extraction module (67), with the majority of the air being recycled to the outside environment through an exhaust vent (65). The extraction module mixes the air and colloid (not shown) and passes it through the Flow Cell (69), which may include further concentration means in alternative embodiments of the present invention. Then the colloid to be tested is passed from the Flow Cell (69) to the Detection Module (71) that produces the Raman-shifted, Emitted Light Spectra (37). From this point on, the physical processing either returns the colloid to the Air Sampling Module (61) or exhausts it to cleanse the detector; while the data transformations begin with the Emitted Light Spectra being sent, preferably through a Fiber Optic Link (73), to the Analysis Module (75). The analysis and comparative results are sent through a link (77) which can be any combination of wired, wireless, or both wired and wireless communication channels between the Analysis Module (75) and the Reporting Module (79), which typically will be a computer or other means for displaying, recording, and correlating the report with other contextual information, or for delivering a real-time warning or, in a further embodiment not shown, automatically reacting to the detected presence of the material (such as shutting down air circulation to contain the spread of contamination, closing blast doors, and alerting and activating contingency operatives and procedures).

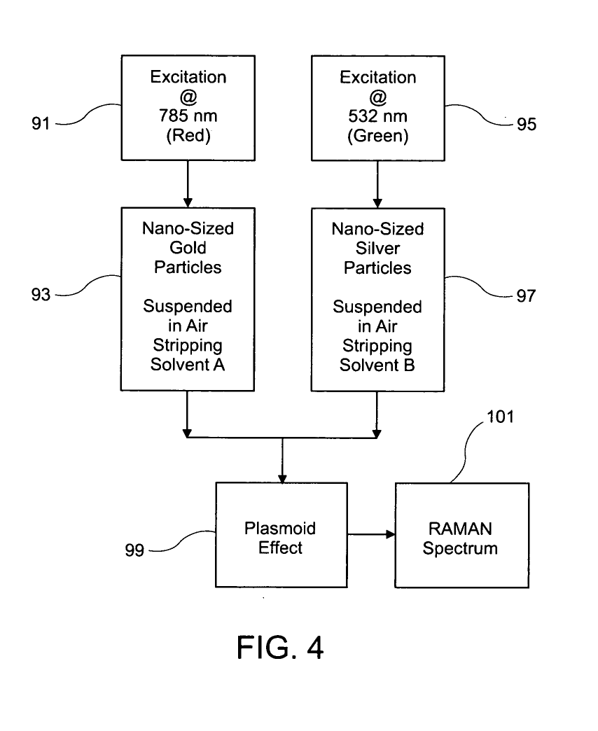

FIG. 4 shows a block diagram for the preferred embodiments of surface impingement within the Raman spectrometer (33). The Raman Scatter is inversely proportional to the fourth power of the wavelength of the excitation light (1/(wavelength)⁴). Therefore using green or lower wavelength light is preferred. However, florescence of the compounds is an interference that masks the Raman spectrum and florescence is greater associated with the green rather than the red excitation light. The advantages of using a green excitation light are offset by the lower excitation light energy available in green light and a lower sensitivity of existing CCD detectors for green rather than for red light. In an alternative embodiment, both red and green laser lights are used, in dual or serial illumination.

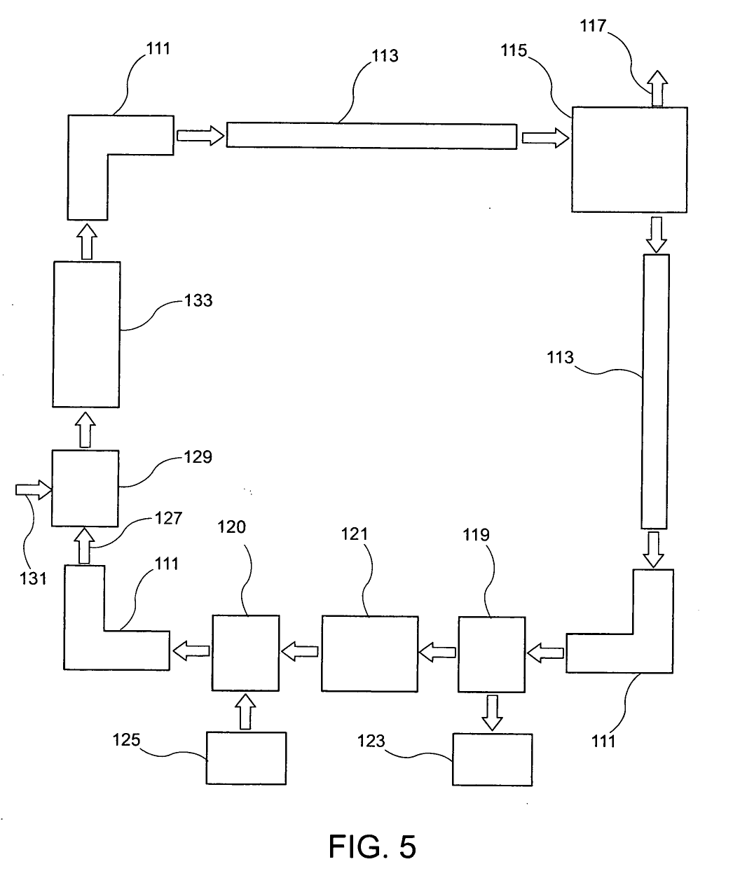

FIG. 5 shows a block diagram of the extraction module. There are two modes of operation. First is the circulation mode, where a colloid (combining a Raman-neutral liquid solvent and suspended particles of a noble metal preferentially nano-sized and with a high surface-to-volume ratio, 15% in the preferred embodiment) strips from the air being sampled trace molecules that were exuded into the air by the compound of interest (in the preferred embodiment, an explosive compound). (In alternatives not shown, different colloidal solutions, varying the solvent or mixture of solvents, or suspended particulates, are used, and are used serially or in parallel). Preferentially an air lift pump circulates the colloid past the intake, through the mixing unit, past a separating unit, to the testing unit, and then, depending on whether the trace molecules have been found or not, either to an exhaust valve or back around again. The second mode of operation is the calibration and re-charging mode, where fresh colloid enters the system and the used colloid is discharged to waste and/or recycling after decontamination. Three-way valves control the flow and accomplish the two modes of operation.

In FIG. 5 can be seen an apparatus for performing the preferred version of the method of the present invention. The air (131) containing trace molecules (as vapor or particles) exuded from the compound(s) of interest enters an intake unit (129), where it encounters the colloid. This colloid is formed of a liquid solvent that is the medium of suspension, has a weak or neutral Raman spectra, and is strongly attractive to the trace molecules, and in which is suspended nano-sized particles of a material strongly attractive to the trace molecules to be detected. The liquid solvent in the preferred embodiment, aimed at detecting one or more explosive compounds, would preferentially be one of the group of acetonitrile, water, and methanol, or in an alternative a mixed solution of all three; all of these liquids both being miscible and preferentially adsorbtive of any trace molecules exuded from the compound(s) whose detection is being targeted. The nano-sized particles of a material strongly attractive to the trace molecules to be detected would be, in the preferred embodiment which is aimed at detecting one or more explosive compounds, made of a noble metal (silver, gold, platinum, iridium, copper, brass); would have an average diameter of 10 nm; and would have at least 15% of their molecules on the surface.

The air being sampled and the colloid would be forced through a mixing unit, a coil having at least 10 turns (133) that would mix the externally-sourced air containing the one or more trace molecules with the colloid and thus maximize the chances for binding between the one or more trace molecules of interest and the nano-sized particles within the colloid by maximizing surface-to-surface interactions between the molecules in both the air sample and the colloid, to form at least one sample to be tested. In the preferred embodiment an air lift pump pumps the colloid through the entire cycle, though direct mechanical pumping of the colloid could also be used. Swirling the air and liquid together maximizes both the air/liquid interface and the opportunities for adsorption of any trace molecules of interest by the surfaces of the nano-sized noble metal nanoparticles suspended in the liquid colloid.

After the air/liquid interaction and mixing, the air would pass through a directing unit (111) and a connecting unit (113) into a first exhaust unit (115). Here the excess air would be exhausted upward to the outside (117) and the now de-aerated sample directed through another connecting unit (113) and directing unit (111) to a first selecting valve (119), which would in the preferred embodiment be a three-way valve. In the preferred embodiment both surface tension and gravity are used to maximize the ease of separating the air from the colloid at the first exhaust unit.

In extensions of the invention, other means for concentrating the trace molecule(s) within the sample would be applied at or prior to this point, though these are not shown in the present drawing. Such means could include solvent-to-solvent extraction, or differentially distributing the concentrations of the liquid solvent and nano-particles within the colloid, thereby creating sub-portions of the liquid solvent with relative concentrations of the nano-particles in contact with the trace molecules, and subjecting only such sub-portions to Raman spectrography. Different means for differentially distributing the concentrations are known in the prior art; these could include, but are not limited to, ionizing the liquid solvent and nano-particles and electromagnetically concentrating the latter in a sub-portion of the former; using a centrifuge or other mass-separation means; or evaporating the liquid solvent, either by adding heat or reducing air pressure (vacuum-evaporation).

From the first selecting valve (119) the sample would be sent to the testing unit (121) where the Raman spectrograph and other means of chemical detection and analysis would be applied. If the sample were not to be tested then it would be diverted instead to a waste outlet (123). From the testing unit (121) the sample would be pulsed onward to a second selecting valve (120). Here, if the presence of the trace molecules of interest had not been detected, the sample could be recycled through another directing unit (111), with or without the addition of more of the colloid from a reservoir (125). As the specifics of Raman spectrography are both well known in the art and described elsewhere in this specification and cited and included materials, the details of that testing unit are not shown herein.

The following examples illustrate, but do not limit, the present invention.

### EXAMPLE 1

The present invention relates to a method to increase the Raman effect by multiple orders of magnitude by impingement and solvent-enhancement wherein the lower limit of detection is increased by providing 500 square meters of surface area for the impingement material made from porous silicon requiring a density approximating 5 molecules of trace material of interest for detection at one part per trillion (ppt) in air that is extracted by a solvent to determine the presence of the trace material of interest to a required density approximating 1 molecule of trace material of interest for detection at one ppt in the solvent to form a target. In this example the impingement material is made from porous silicon of nano-size structure of hollow or preferably tubular cross-section along its minor axis and said nano-size structures are arranged on a rigid substrate including silicon or flexible substrate such as polymeric films. A solvent is used to extract the trace materials resident on the impingement material, said solvent being selected from a group of solvents wherein the trace material has sufficient solubility to place the trace material in solution, where the Raman spectrum of the selective solvent is weak and unobtrusive allowing the acquisition of the trace material's solutes' spectrum in solution. In this example the quantity of a trace material of interest (e.g. TNT) when tested positive for the presence of TNT is determined by creating and storing a database of spectrums from analysis of reference samples of different concentrations of TNT, measuring and storing the relative heights of a minimum of two characteristic peaks in these spectra and comparing relative heights of the spectra of the sample to the database of spectra for reference samples, thus allowing the detection to report not just the presence but the intensity (and thus relative concentration, and thus detected volume) of TNT present.

### EXAMPLE 2

The present invention relates to a method to increase the Raman effect by multiple orders of magnitude by solvent-enhancement and impingement wherein the impingement material is made from materials used in Affinity type High Performance Liquid Chromatograph (HPLC) that bind to proteins —NH₂ and —COOH groups and the impingement material is made from pressure stable polymers, cross-linked agarose or polyacrylamide gels. In this example the solvent used to extract the trace materials resident on the impingement material is water and a computer analyzes and compares spectra to known spectra and communicates to physically separate instruments and computers. The sensor, utilizing one or dual wavelength near infrared laser light sources matched to at least one Charged Coupled Device (CCD) detector, senses spectra of Raman scattered light for sampled suspected of containing trace molecules of interest, and both is mounted remotely and communicates through Bluetooth software and equipment to a single computer, or multiple computers, to provide redundant or multiple points of monitoring. This computer/these computers perform the data calculations and comparison to the stored databases to determine the presence and concentration of one or more of the trace materials of interest.

### EXAMPLE 3

In this example the focusing wavelengths of light incident on the target sample are in the near infra-red region with one mono-chromatic laser light source at 785 nm and the other removed by one-half of the Raman spectrum band for the trace molecules of interest, or 200 to 150 nm shorter wavelength, so that the sensitivity to trace materials of interest is enhanced and florescence from the target is subtracted to improve the clarity of the Raman spectrum.

### EXAMPLE 4

In this example the illumination is with a single laser at a nominal wave length of 785 nm and the spectrum of Raman scattered light is collected by an optically straightened circular hologram grating and measured by a X-Y photo-electronic array in visible light and near infrared range of 400 to 1,000 nm. The target is a cylindrical curvet that functions when it containing a minimum of 50 micoliters and also functions at increased sample volume to a maximum of 200 micoliters of water solvent. The materials of interest that are to be detected in the liquid solution containing acetonitrile are Royal Demolition Explosive (RDX), as an indication of the presence of Plastic Explosives, and Tri-Nitro-Toluene (TNT), as an indication of the presence of Dynamite of Plastic Explosives. The Raman bands are calculated in a portable computer by subtracting incident light wave length from the electronic signal from the photo-electronic array and the resulting Raman bands are compared to store Raman bands for the materials of interest and the match or no-match conclusion of the analysis is outputted.

### EXAMPLE 5

In this example the sensor continually runs the colloid through the sampling unit, taking in air; mixes the air and colloid to maximize the liquid/air and trace molecule adsorption to a surface of a noble metal nanoparticle, thereby concentrating the trace molecules of interest into the sample to be tested, performs Raman spectroscopy on the sample, reports the result, and repeats the above cycle rapidly, thereby continuing to increase the concentration as more and more of the trace molecules of interest are encountered, until passing over a detection threshold that allows a positive alert. At that point the detection is reported, after which the sample is flushed and a new, non-contaminated amount of the liquid colloid is allowed to flow into the sensor, thereby re-setting it for reuse.

### EXAMPLE 6

Another approach to enhancing the detection takeS advantage of the volumetric, three-dimensional nature of the sample and, instead of using one laser, uses two whose emission beams intersect at the sample volume. The sensor then combines the Raman scattering to correct for polarization and other blockage problems. A further extension of this approach has one, or both, of the lasers track through different and intersecting planes of the volume in which the sample is located to maximize the impingement of the emission beam on any trace molecule(s) present and thus the emission of the Raman scattering from the trace molecule(s).

There are other important applications for the sniffer. In addition to explosives, this invention can be used to develop a sensor that can detect other volatile chemicals and drugs (including cocaine, thebaine and barbital). There also is the ability to take an otherwise unknown or unidentified sample to program the sensor and then program the sensor to find the chemical in that sample.

This could be particularly important in analyzing the head space above urine, serum of other human fluids of breath for presumption of cancer. Samples from one or more known cancer-diseased individuals can be used to program the detector. The following are several examples of substances manifested from cancer disease that are detectable in these headspaces or breaths:
a. Volatile organic compounds (VOCs), principally alkanes, benzene derivatives and such ‘aromatic compounds’, that have been identified in breath from patients with lung cancer.
b. Formaldehyde, that has been identified in the headspace of urine from bladder and prostate cancer patients.
c. The relative abundance of VOCs in the breath and the presence of polymorphic cytochrome P-450 mixed oxidase enzymes (CYP) have accompanied breast cancer, because oxidative stress causes lipid peroxidation of polyunsaturated fatty acids in membranes, producing alkanes and methylalkanes which are catabolized by CYP.
d. Urinary pheomelanin and eumelanin metabolites, 5-S-cysteinyldopa and indoles, 5(6)-hydroxy-6(5)-methoxyindole-2-carboxylic acid, potential eumelanin precursor metabolites in the urine that may serve as markers for melanoma metastases.
e. 5-S-cysteinyldopa and indoles (5,6-dihydroxyindole-2-carboxylic acid plus 6-hydroxy-5-methoxyindole-2-carboxylic acid) above 1 mumol/d and 2 mumol/d, respectively, considered significant amounts in the urine of melanoma patients with positive metastasis; or in lesser amounts, these melanin metabolites may be a signal of metastasis-free melanoma in patients.

While there has been described what are presently believed to be the preferred embodiments of the present invention those skilled in the art will realize that changes and modifications maybe made thereto without departing from the spirit of the invention. It is intended to claim all such changes and modifications that fall within the true scope of the invention.

I claim:

1. A method to increase the sensitivity of the Raman effect by multiple orders of magnitude, allowing detection of one or more trace molecules that are exuded from a chemical compound of interest and present in a medium, thus enabling a real-time, stand-off sensor, comprising:
selecting as an impingement base a colloid, said colloid comprising:
a liquid solvent forming a medium of suspension;
into which particles of a material strongly attractive to the one or more trace molecules, are suspended;
taking a sample from the sensor's environment by pumping the colloid through a sampling unit, thereby exposing the colloid to the medium where the one or more trace molecules may be present;
maximizing, throughout the volume of the sample, the surface-to-surface interaction between the medium and colloid, thereby maximizing the interaction between the surfaces of the suspended particles with the one or more trace molecules;
binding one or more of the particles within the colloid with one or more of the trace molecules, as a result of such interaction;
focusing a monochromatic laser light on said sample;
generating thereby Raman spectra from said sample;
producing a re-constructed Raman spectra of the one or more trace molecules by eliminating from the generated Raman spectra both Rayleigh scatter and Raman scattering from the colloid before it was mixed with the medium;
comparing said re-constructed Raman spectra to Raman spectra contained in a database of Raman spectra for known chemical compounds, to determine the presence of one or more trace molecules exuded from the chemical compound of interest; and,
reporting the result of the preceding steps.

2. A method as set forth in claim 1, wherein the step of selecting as an impingement base a liquid solvent specifically selects a liquid solvent that:
has a neutral or weak Raman spectra; and,
is strongly attractive to the trace molecules of the compound of interest.

3. A method as set forth in claim 2, wherein the step of selecting as an impingement base a colloid specifically uses acetonitrile for the liquid solvent forming a medium of suspension.

4. A method as set forth in claim 2, wherein the step of selecting as an impingement base a colloid specifically uses water for the liquid solvent forming a medium of suspension.

5. A method as set forth in claim 2, wherein the step of selecting as an impingement base a colloid specifically uses methanol for the liquid solvent forming a medium of suspension.

6. A method as set forth in claim 2, wherein the step of selecting as an impingement base a colloid specifically uses a mixture of acetonitrile, methanol, and water for the liquid solvent forming a medium of suspension.

7. A method as set forth in claim 1, wherein the step of selecting as an impingement base a colloid comprising a liquid solvent forming a medium of suspension, into which particles of a material strongly attractive to the one or more trace molecules, are suspended, further comprises using particles of a material that both:
preferentially are nano-sized;
have at least 15% of each particle's molecules forming the surface of that particle; and,
are strongly attractive to the one or more trace molecules.

8. A method as set forth in claim 7, wherein the particles suspended in the colloid are furthermore of an average size below the wavelength of the monochromatic laser light that will illuminate the sample.

9. A method as set forth in claim 1, further comprising, after having one or more of the particles within the sample contact and bind with one or more trace molecules, as a result of such interaction, processing the sample so that any trace molecules are concentrated therein.

10. A method as set forth in claim 9, wherein processing the sample so that any trace molecules are concentrated therein further comprises extracting the majority of the trace molecules from the colloid with a second solvent, said second solvent selected from a group of solvents that are both capable of solvent-to-solvent extraction and have a Raman spectrum that can be subtracted, whether weak, compared to the trace molecules, unobtrusive, or known beforehand.

11. A method as set forth in claim 9, wherein processing the sample so that any trace molecules are concentrated therein further comprises differentially distributing the concentrations of the liquid solvent and nano-particles in the colloid.

12. A method as set forth in claim 11, wherein the step of differentially distributing the concentrations of the liquid solvent and nano-particles in the colloid comprises first ionizing the liquid solvent and nano-particles and then electromagnetically concentrating the nano-particles in a sub-portion of the liquid solvent.

13. A method as set forth in claim 11, wherein the step of differentially distributing the concentrations of the liquid solvent and nano-particles in the colloid comprises concentrating the nano-particles by centrifuge.

14. A method as set forth in claim 9, wherein the step of processing the sample so that any trace molecules are concentrated therein comprises evaporating the majority of the liquid solvent.

15. A method as set forth in claim 14, wherein the step of evaporating the majority of the liquid solvent is done using reduced air pressure.

16. A method as set forth in claim 14, wherein the step of evaporating the liquid is done using heat.

17. A method as set forth in claim 1, using alternatively an impingement base made from porous silicon having a nano-sized structure that provides at least 500 square meters of surface area, requires a density approximating 5 trace molecules of interest for detection at one part per trillion (ppt) in air that is extracted by water or other solvent to determine the presence of the trace molecules of interest to a required density approximating 1 trace molecule of interest for detection at one ppt for impingement materials made from nano-structures of precious metals.

18. A method as set forth in claim 1, further comprising combining Raman Spectography and other molecular detection means.

19. A method as set forth in claim 18, wherein the step of combining Raman Spectography and other molecular detection means further comprises:
using an impingement base made from materials used in Affinity type High Performance Liquid Chromatography (HPLC); and,
using both Raman spectrography and HPLC to analyze the sample.

20. A method as set forth in claim 1, wherein the monochromatic laser light is tuned to maximize the sensitivity and specificity of the resulting Raman spectrographic detection and analysis.

21. A method as set forth in claim 20, further comprising:
selecting as an impingement base a colloid comprising a liquid solvent forming a medium of suspension into which are suspended nano-particles providing a surface area that strongly attracts the one or more trace molecules, said particles:
being particles of precious metal;
averaging 10 nm in diameter; and,
having 15% or more of their total molecules on the surface; and,
using gold as the particles of precious metal when the monochromatic laser light is red, and silver as the particles of precious metal when the monochromatic laser light is green.

22. A method as set forth in claim 20 wherein the monochromatic laser light has an excitation wavelength in the range of 785 nm to 996 nm, in the red region of the spectrum.

23. A method as set forth in claim 20 wherein the monochromatic laser light has an excitation wavelength in the range of 532 nm to 676 nm, in the green region of the spectrum.

24. A method as set forth in claim 20, wherein:
the monochromatic laser light is defocused so as to illuminate the volume of the sample; and,
a further step of volumetric integration of the Raman Scatter from the particles' surfaces is done to produce a generated Raman spectra.

25. A method as set forth in claim 20, further comprising using at least dual simultaneous operations to cross-correct for errors.

26. A method as set forth in claim 25, wherein the step of using at least dual simultaneous operations to cross-correct for errors further comprises:
using at least two monochromatic lasers whose emission beams cross at the sample; and,
combining the Raman scattering, to correct for polarization and other blockage problems.

27. The method as in claim 26, further comprising having the at least two monochromatic lasers track through different and intersecting planes of the volume of the sample.

28. A method as set forth in claim 25, wherein the step of using at least dual simultaneous operations to cross-correct for errors further comprises:
using dual monochromatic lasers to correct for florescence interferences; and,
allowing the use of two solvents, wherein one is acetonitrile, and the other solvent is from the set of water, methanol, or a combination solution of water and methanol.

29. A method as set forth in claim 26, further comprising:
using at least a first and second monochromatic laser lights; and,
setting the excitation wavelength of the first monochromatic laser light in the near infra-red region; and,
setting the exitation wavelength of the second monochromatic laser light removed from the excitation wavelength of the first laser light by one-half of the Raman spectrum band for the one or more trace molecules;
so that the sensitivity to the one or more trace molecules is enhanced and florescence associated with any source including from the liquid solvent, particles, trace molecules, and any particulate or non-important additional solutes, is subtracted to enhance the generated Raman spectra.

30. A method as set forth in claim 1, wherein the colloid incorporates a binding agent for one or more trace molecules exuded from a Volatile Organic Compound.

31. A method as set forth in claim 30, wherein the binding agent further comprises at least one of the following set of Volatile Organic Compounds:
a. alkanes, benzene derivatives and such ‘aromatic compounds’, that have been identified in breath from patients with lung cancer;
b. formaldehyde identified in the headspace of urine from bladder and prostate cancer patients;
c. Polymorphic cytochrome P-450 mixed oxidase enzymes (CYP) and producing alkanes and methylalkanes which are catabolized by CYP, that have accompanied breast cancer;
d. Urinary pheomelanin and eumelanin metabolites, 5-S-cysteinyldopa and indoles, 5(6)-hydroxy-6(5)-methoxyindole-2-carboxylic acid, as potential eumelanin precursor metabolites in the urine that may serve as markers for melanoma metastases; and,
e. 5-S-cysteinyldopa and indoles (5,6-dihydroxyindole-2-carboxylic acid plus 6-hydroxy-5-methoxyindole-2-carboxylic acid) above 1 mumol/d and 2 mumol/d, respectively, that may be considered significant amounts in the urine of melanoma patients with positive metastasis.

32. A method as set forth in claim 1, wherein the incorporates a binding agent for one or more trace molecules exuded from an illegal drug, specifically including but not being limited to any of cocaine, thebaine and barbital.

33. A method as set forth in claim 1, extending the sensor's flexibility and usability through programming the sensor to detect a new chemical compound of interest, said method comprising:
introducing into the sensor's sampling unit a base sample containing trace molecules of a new chemical compound of interest;
engaging in the steps of maximizing, binding, focusing, and thereby generating a resulting Raman spectra for the base sample;
adding that resulting Raman spectra to the database;
flushing the sensor of the base sample; and,
subsequently comparing Raman spectra from each sample against the expanded database.

34. A method as set forth in claim 1, for detecting more than one specific chemical compound of interest, further comprising:
selecting and using more than one colloid;
each colloid differing from the other colloids by incorporating a unique combination of liquid solvent and particles comprised of a material most strongly attractive to the one or more trace molecules exuded from an exclusive sub-set of the specific chemical compounds of interest;
thereby improving the detectable lower limit for some or all of the trace molecules in the population of trace molecules of all specific chemical compounds of interest, when compared to the performance of any single colloid.

36. A method as set forth in claim 1, wherein at least one computer analyzes and compares the generated Raman spectra to known Raman spectra and communicates to physically separated instruments and computers by:
using at least one wavelength near infrared laser light source matched to a Charged Coupled Device (CCD) detector mounted remotely to sense Raman spectra for samples suspected of containing one or more trace molecules; and
communicating through Bluetooth software and equipment to more than a single computer to provide redundant or multiple points of monitoring, produce the re-constructed Raman spectra, and compare that to the Raman spectra contained in the database, to determine the presence and concentration of one or more of the trace molecules, and report the result.

37. A method as set forth in claim 1, further comprising the additional step of:
prior to exposing the sample to the external environment, performing the steps of:
focusing a monochromatic laser light on an unexposed sample;
generating thereby Raman spectra from the unexposed sample;
storing the Raman spectra from the unexposed sample as a corrective to be applied to subsequent tests; and,
when performing the step of producing a re-constructed Raman spectrum of the trace molecules by eliminating from the generated Raman spectra both Rayleigh scatter and Raman scattering from the pre-contact colloid, removing the stored Raman spectra from the unexposed sample from the generated Raman spectra from the exposed sample.

38. A method to increase the Raman effect by multiple orders of magnitude by impingement and solvent enhancement of particulate or vapor materials in air or from materials found on surfaces or in liquids so that trace materials can be detectable comprising:
selecting an impingement material constructed from a material characterized with the requisite surface chemical and sufficient surface area characteristics for concentrating the materials of interest,
contacting trace material with said impingement material,
extracting trace material from the impingement material with a solvent and further process said solvent so that the trace material of interest is contained in liquid to form a target at sufficient concentration of the trace material present to exhibit a detectable Raman effect,
focusing a light incident on said target and receiving Raman spectra from said target to accomplish analysis by one mono-chromatic laser light source followed by another mono-chromatic light laser light source with an appropriately selected different wavelength and subtract one of the Raman spectra resulting from said first laser source from the Raman spectra resulting from the second laser source and produce a re-constructed Raman spectra using the body of knowledge available from literature on Raman spectra;
comparing said re-constructed Raman spectra to a database containing Raman spectra of known materials of interest to determine the presence and concentration of one or more of the trace materials of interest; and,
reporting the result of the preceding steps.

39. A method as set forth in claim 38, wherein said impingement material is made from materials used in Affinity type High Performance Liquid Chromatograph (HPLC) that bind to proteins —NH₂ and —COOH groups and said target is made from pressure stable polymers, cross-linked agarose or polyacrylamide gels. (size below wavelength)

40. A method as set forth in claim 1, further comprising:
changing a flow plane, between horizontal and vertical planes, of the circulation of the colloid, as it moves from sampling to being illuminated, in order to alter any illumination time and any latent time between any trace molecules entering the sensor and being detected.
